(19) United States
(12) Patent Application Publication
(10) Pub. No.: US 2026/0231854 A1
(43) Pub. Date: Aug. 13, 2026

(54) NOVEL SYSTEMS FOR PLANTING SEAGRASSES WITHIN A SUBAQUATIC SUBSTRATE AND METHODS RELATED THERETO

(71) Applicant: ReefGen, Inc., San Francisco, CA (US)

(72) Inventors: Christopher Oakes, Piedmont, CA (US); David Solomon, San Francisco, CA (US); Daniel Hennage, San Mateo, CA (US); Paul Silberschatz, San Francisco, CA (US); Nastasia Winey, San Francisco, CA (US); Young Park, San Mateo, CA (US); Zachary Radding, San Francisco, CA (US); Peter Chow, San Francisco, CA (US)

(73) Assignee: ReefGen, Inc., San Francisco, CA (US)

(21) Appl. No.: 19/539,080

(22) Filed: Feb. 13, 2026

Related U.S. Application Data
(60) Provisional application No. 63/757,815, filed on Feb. 13, 2025.

(51) Int. Cl. A01C 14/00

(52) U.S. Cl. CPC A01C 14/00

(57) ABSTRACT

A seagrass planting system for planting seagrass segments within a subaquatic substrate may include a conveyance subassembly having a conveyance tube extending from a surface location to a subaquatic planter. A seagrass planting subassembly positioned on the subaquatic planter includes a diverter fluidly coupled to the conveyance tube, a plurality of planting guides each having a planting channel, a plurality of doors, and a plurality of insertion rams. The diverter selectively directs fluid flow to an exhaust port or to one of a plurality of fluidic pathways leading to the planting guides. During operation, the diverter sequentially directs fluid flow to the exhaust port during conveyance of a planting spike, to a selected fluidic pathway to position the planting spike within a planting channel against a door, and back to the exhaust port before opening the door and actuating an insertion ram to push the planting spike into the subaquatic substrate.

### RELATED APPLICATION

This application claims the benefit of U.S. Provisional Application No. 63/757,815, filed Feb. 13, 2025, the entire contents of which are incorporated herein by reference.

### FIELD

The present invention generally relates to systems and methods for planting seagrass within an underwater or subaquatic substrate. More particularly, the present invention relates to autonomous or semi-autonomous systems and methods for planting seagrass segments directly into subaquatic substrates such as the seafloor.

### BACKGROUND

Seagrasses are flowering plants that live in submerged or periodically submerged aquatic environments. Although seagrass meadows occupy only about 0.1% to 0.2% of the ocean floor, they provide critical habitat for marine life and serve essential ecological functions. Seagrass environments protect coastlines by absorbing wave energy, thereby preventing erosion and reducing damage caused by storms, hurricanes, and cyclones. Additionally, seagrass habitats provide vital food and economic resources to coastal communities worldwide and serve as an important means of carbon and nutrient sequestration.

Unfortunately, subaquatic flora habitats are rapidly disappearing due to pollutants, climate change, increasing water temperatures, and changes in water composition. Efforts to regenerate or regrow these habitats by planting seagrass have proven to be slow, difficult, labor-intensive, and expensive. Traditional methods often require divers to manually plant individual seagrass segments into the substrate, which limits the scale and efficiency of restoration efforts.

Accordingly, there is a need for improved systems and methods to regenerate subaquatic flora habitats by planting seagrasses in a quick, efficient, and cost-effective manner.

### SUMMARY

The present invention relates to systems and methods for planting seagrass segments within a subaquatic substrate.

In some aspects, the present arrangements offer novel seagrass planting systems. One such seagrass planting system includes a conveyance subassembly configured to receive planting spikes from a surface location, the conveyance subassembly including a conveyance tube having a first end and a second end. A subaquatic planter is coupled to the conveyance subassembly and is configured to operate underwater. A seagrass planting subassembly is positioned on the subaquatic planter and includes a diverter fluidly coupled to the second end of the conveyance tube. The diverter selectively directs fluid flow to an exhaust port or to one of a plurality of fluidic pathways.

The seagrass planting subassembly includes a plurality of planting guides, each planting guide associated with one of the plurality of fluidic pathways. Each planting guide has a planting channel configured to receive a planting spike from its associated fluidic pathway. A plurality of doors are provided, each door associated with one of the plurality of planting guides. Each door retains a planting spike within the planting channel and inhibits fluid flow through the planting channel. In an operative state, the planting spike, under the force of fluid flow, displaces towards the door. A plurality of insertion rams are included, each insertion ram associated with one of the plurality of planting guides. Each insertion ram moves from a retracted position to an extended position to push the planting spike from the planting channel into the subaquatic substrate.

During planting of the planting spike, the diverter sequentially directs fluid flow to the exhaust port, to one of the plurality of fluidic pathways to facilitate conveyance of the planting spike within the planting channel adjacent to one of the plurality of doors, and to the exhaust port prior to opening the door and actuating one of the plurality of insertion rams to push the planting spike into the subaquatic substrate.

In one embodiment of the present arrangements, the diverter includes a rotating valve controlled by a diverter motor. The rotating valve directs fluid flow to the exhaust port or one of the plurality of planting guides. In another embodiment of the present arrangements, the rotating valve directs fluid flow to a first fluidic pathway to facilitate conveyance of a first planting spike adjacent to a first door, and to the exhaust port prior to opening the first door, to a second fluidic pathway to facilitate conveyance of a second planting spike adjacent to a second door, and to the exhaust port prior to opening the second door.

In one aspect of the present arrangements, each door is actuatable between a closed position and an open position. In the closed position, the door retains the planting spike within the planting channel and prevents fluid flow through the door so as to minimize disturbance upon the subaquatic substrate.

In another embodiment of the present arrangements, each insertion ram includes pushing tangs configured to engage a force receiving end of the planting spike. When the insertion ram is in the retracted position, the pushing tangs are in a recessed position that does not engage the planting spike when the planting spike is positioned within the planting channel. When the insertion ram is moving from the retracted position to the extended position, the pushing tangs extend into the planting channel and engage with the force receiving end of the planting spike to push the planting spike into the subaquatic substrate.

In one embodiment of the present arrangements, the diverter includes one or more apertures defined therethrough. The one or more apertures exhaust fluid from the selected one of the plurality of fluidic pathways, thereby controlling fluid pressure and/or fluid flow rate within the fluidic pathways.

In another aspect of the present arrangements, the system includes at least a first insertion ram and a second insertion ram, each associated with a different planting guide. The seagrass planting subassembly sequentially plants planting spikes using the first insertion ram and the second insertion ram.

In one embodiment of the present arrangements, the conveyance subassembly further includes a swivel mechanism mounted on the subaquatic planter. The swivel mechanism includes an outer ring configured to be coupled to the subaquatic planter, an inner ring rotatably coupled to the outer ring, and a rotating plate coupled to the inner ring and to the conveyance tube. The swivel mechanism decouples rotational movement between the subaquatic planter and the conveyance tube.

In another embodiment of the present arrangements, the system further includes a bi-directional pump fluidly coupled to the conveyance subassembly. The bi-directional pump controls direction and rate of fluid flow through the conveyance subassembly.

In one aspect of the present arrangements, the system further includes at least one vibrating motor coupled to at least one of the plurality of insertion rams. The vibrating motor vibrates the insertion ram during insertion of the planting spike into the subaquatic substrate to cause liquefaction of the subaquatic substrate and reduce insertion force.

In some aspects, the techniques described therein relate to methods for planting seagrass segments within a subaquatic substrate. One such method includes inserting a planting spike containing a seagrass segment into a conveyance subassembly at a surface location, the conveyance subassembly including a conveyance tube having a first end and a second end. The method further includes an element of directing fluid flow, using a diverter fluidly coupled to the second end of the conveyance tube, to an exhaust port to convey the planting spike through the conveyance tube to a seagrass planting subassembly positioned on a subaquatic planter. The method includes diverting the fluid flow, using the diverter, from the exhaust port to one of a plurality of fluidic pathways to facilitate conveyance of the planting spike within a planting channel of a corresponding planting guide, wherein the planting spike, under the force of fluid flow, displaces towards a door associated with the planting guide. The method includes diverting the fluid flow, using the diverter, back to the exhaust port, opening the door, and actuating an insertion ram associated with the planting guide to move from a retracted position to an extended position to push the planting spike from the planting channel into the subaquatic substrate.

In one embodiment of the present teachings, the diverter includes a rotating valve, and directing fluid flow includes rotating the rotating valve to select between the exhaust port and the selected one of the plurality of fluidic pathways.

In another aspect of the present teachings, the method further includes maintaining fluid flow through the conveyance subassembly during positioning of the planting spike within the planting channel to hold the planting spike in position against the door.

In one embodiment of the present teachings, the method further includes activating a vibrating motor coupled to the insertion ram during the actuating of the insertion ram to cause vibration of the planting spike and liquefaction of the subaquatic substrate.

In another embodiment of the present teachings, the method further includes inserting a second planting spike containing a seagrass segment into the conveyance subassembly, diverting fluid flow to position the second planting spike within a second planting channel of a second planting guide while the insertion ram is pushing the first planting spike into the subaquatic substrate, and actuating a second insertion ram to push the second planting spike into the subaquatic substrate after the first planting spike has been inserted.

In one aspect of the present teachings, the fluid flow includes water from the subaquatic environment in which the subaquatic planter is disposed.

In another embodiment of the present teachings, directing fluid flow to the exhaust port during conveyance prevents fluid flow through the plurality of fluidic pathways and the planting channels, thereby preventing disturbance of sediments on the subaquatic substrate.

In one embodiment of the present teachings, the method further includes adjusting a flow rate of the fluid flow using a bi-directional pump positioned between the surface location and the subaquatic planter. In another aspect of the present teachings, the method further includes reversing the direction of fluid flow using the bi-directional pump to reposition a planting spike that is stuck within the conveyance subassembly or the diverter.

In one embodiment of the present teachings, the method further includes maneuvering the subaquatic planter to a desired planting location on the subaquatic substrate using propulsion systems positioned on the subaquatic planter.

The construction and method of operation of the arrangements and teachings, however, together with additional objects and advantages thereof, will be best understood from the following descriptions of specific embodiments when read in connection with the accompanying figures.

### BRIEF DESCRIPTION OF THE FIGURES

FIG. 1 shows a seagrass planting system according to one embodiment of the present invention.

FIG. 2 shows a seagrass planting subassembly and conveyance subassembly according to one embodiment of the present invention.

FIG. 3 shows the conveyance subassembly of FIG. 2, including a swivel mechanism.

FIG. 4 shows a conveyance subassembly including a pressure relief port and flow control mechanism according to one embodiment of the present invention.

FIG. 5A shows a diverter, according to one embodiment of the present arrangements, that includes a rotating valve that directs fluid flow to a plurality of fluidic pathways and/or an exhaust port.

FIG. 5B shows an expanded view of the rotating valve of FIG. 5A.

FIG. 5C shows an exploded view of the diverter and rotating valve of FIG. 5A, showing that the rotating valve allows fluid flow only to a selected plurality of fluidic pathways or the exhaust port.

FIG. 6 shows a seagrass planting subassembly according to one embodiment of the present invention.

FIG. 7 shows an exploded view of a seagrass planting subassembly according to one embodiment of the present invention.

FIG. 8A shows a cross-sectional view of a seagrass planting subassembly, according to one embodiment of the present invention, with an insertion ram in a retracted position.

FIG. 8B shows a cross-sectional view of the seagrass planting subassembly of FIG. 8A with an insertion ram moving from the retracted position to an extended position.

FIG. 9 shows a flowchart illustrating a method for planting seagrass segments within a subaquatic substrate according to one embodiment of the present invention.

### DETAILED DESCRIPTION

In the following description, numerous specific details are set forth in order to provide a thorough understanding of the present invention. It will be apparent, however, to one skilled in the art that the present invention may be practiced without limitation to some or all of these specific details. In other instances, well-known process steps have not been described in detail in order to not unnecessarily obscure the present invention. Like reference numerals in the drawings denote like elements throughout the specification.

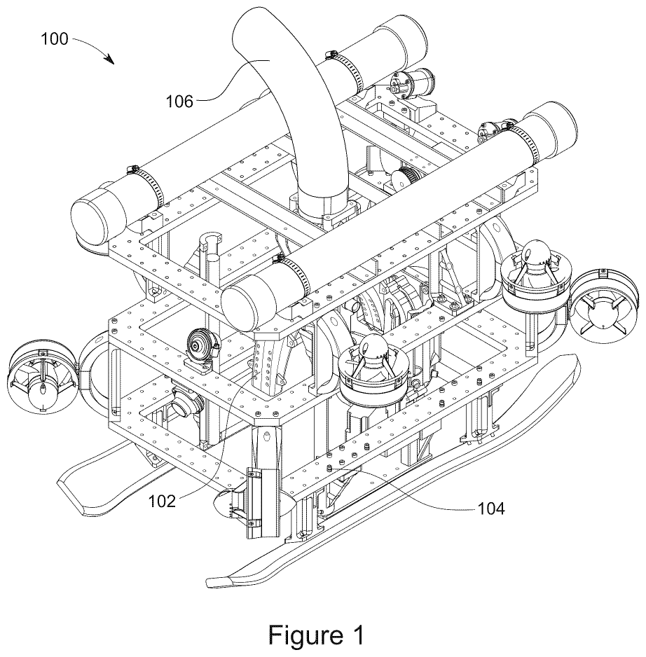

FIG. 1 shows a seagrass planting system 100 according to one embodiment of the present invention. The seagrass planting system 100 includes a seagrass planting subassembly 102 and a conveyance subassembly 106 coupled to a subaquatic planter 104. Subaquatic planter 104 is configured to operate underwater and includes a frame structure with skis for maneuvering over a subaquatic substrate. Subaquatic planter 104, in one implementation of the present arrangements, includes propulsion systems positioned on opposite sides of the frame to control pitch, roll, yaw, and movement in lateral and longitudinal directions. In one embodiment of the present arrangements, the propulsion systems include ducted thrusters that enable the seagrass planting system 100 to traverse along the subaquatic substrate and position itself at desired planting locations.

Conveyance subassembly 106, in one aspect of the present arrangements, is configured to receive planting spikes from a surface location and includes a conveyance tube that extends from a first end configured to receive planting spikes to a second end adjacent to seagrass planting subassembly 102. Seagrass planting subassembly 102 is positioned beneath conveyance subassembly 106 on the subaquatic planter 104 and receives planting spikes from the conveyance subassembly 106 and inserts the planting spikes into the subaquatic substrate.

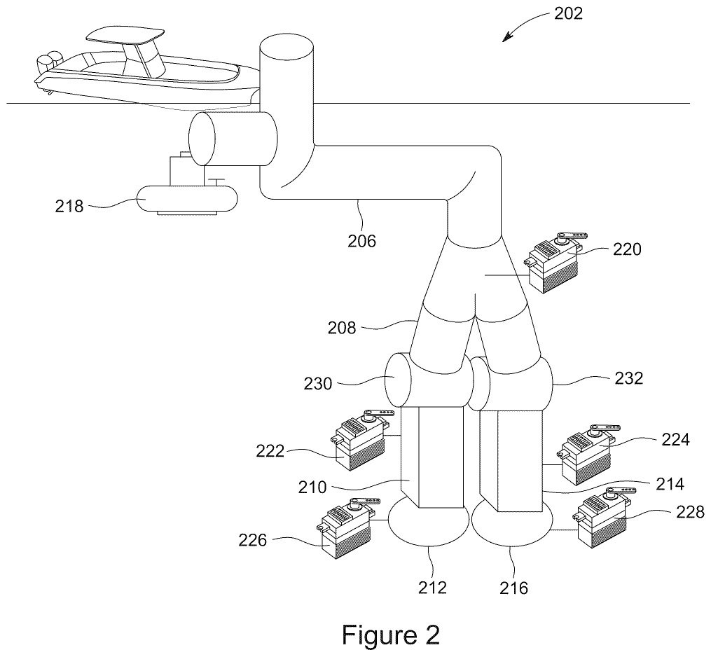

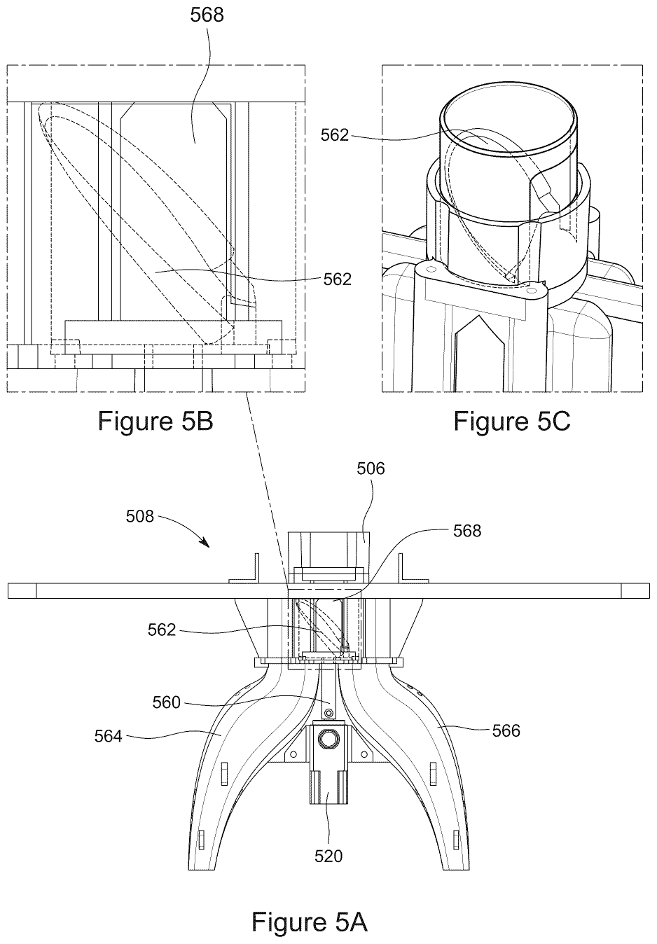

FIG. 2 shows a seagrass planting subassembly 202 and a conveyance subassembly 206 according to one embodiment of the present invention. Seagrass planting subassembly 202 includes a diverter 208 fluidly coupled to conveyance subassembly 206. Diverter 208 is configured to selectively direct fluid flow to an exhaust port and/or to one of a plurality of fluidic pathways. In the illustrated embodiment, diverter 208 includes a rotating valve controlled by a diverter motor 220. The rotating valve is configured to rotate to select between directing fluid flow to the exhaust port and/or to one of the plurality of fluidic pathways (e.g., first fluidic pathway 564 and second fluidic pathway 566 of FIG. 5).

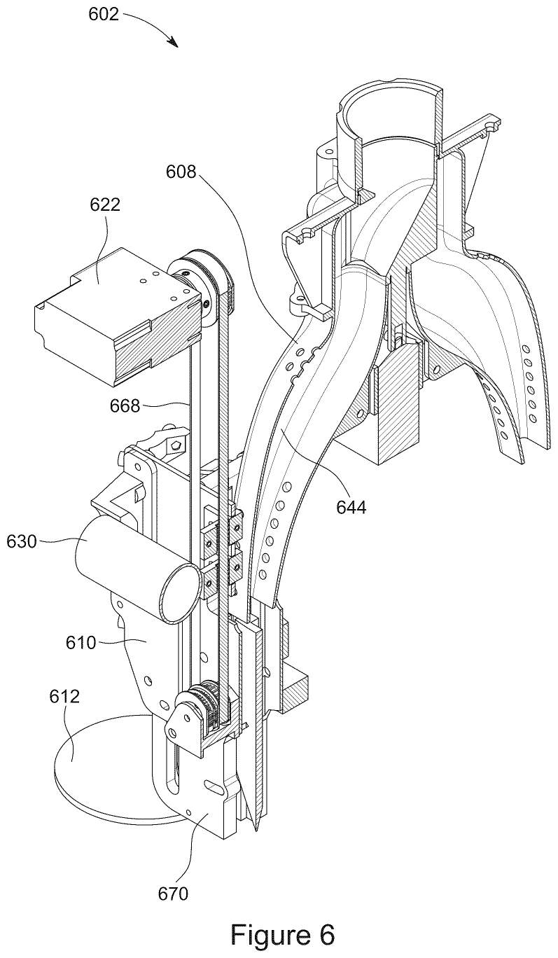

Seagrass planting subassembly 202 further includes a plurality of planting guides (e.g., planting guide 670 of FIG. 6), each planting guide associated with one of the plurality of fluidic pathways. Each planting guide has a planting channel configured to receive a planting spike from its associated fluidic pathway. Seagrass planting subassembly 202 includes a plurality of doors configured to retain planting spikes within the planting channels and inhibit fluid flow through the planting channels. In the illustrated embodiment, a first door 212 is associated with a first planting guide, and a second door 216 is associated with a second planting guide. First door 212 is actuatable by a first door motor 226, and second door 216 is actuatable by a second door motor 228. While the illustrated embodiment shows two fluidic pathways, it will be understood that the system can include three, four, five, or more fluidic pathways, each associated with a corresponding planting guide, door, and insertion ram, to increase planting throughput.

Seagrass planting subassembly 202 includes a plurality of insertion rams configured to push planting spikes from the planting channels into the subaquatic substrate. In the illustrated embodiment, a first insertion ram 210 is associated with the first planting guide and is configured to move from a retracted position to an extended position to push a planting spike into the subaquatic substrate. First insertion ram 210 is actuated by a first insertion motor 222. A second insertion ram 214 is associated with the second planting guide and is actuated by a second insertion motor 224.

In one embodiment, seagrass planting subassembly 202 includes vibrating motors coupled to the insertion rams. A first vibrating motor 230 is coupled to first insertion ram 210, and a second vibrating motor 232 is coupled to second insertion ram 214. The vibrating motors are configured to vibrate the insertion rams during insertion of the planting spikes into the subaquatic substrate to cause liquefaction of the subaquatic substrate and reduce insertion force.

The system further includes a bi-directional pump 218 fluidly coupled to conveyance subassembly 206. Bi-directional pump 218 is configured to control the direction and rate of fluid flow through conveyance subassembly 206. In one embodiment of the present arrangements, bi-directional pump 218 is positioned between the surface location and the subaquatic planter, and can be used to adjust fluid flow rate or reverse the direction of fluid flow to reposition a planting spike that becomes stuck within conveyance subassembly 206 or diverter 208. In one embodiment, the fluid includes seawater or freshwater from the subaquatic environment in which the subaquatic planter operates. In another embodiment, the fluid may be supplied from a surface vessel via a hose or umbilical. In yet another embodiment, the fluid may be a mixture of ambient water and additives such as nutrients, growth hormones, or protective coatings for the seagrass segments.

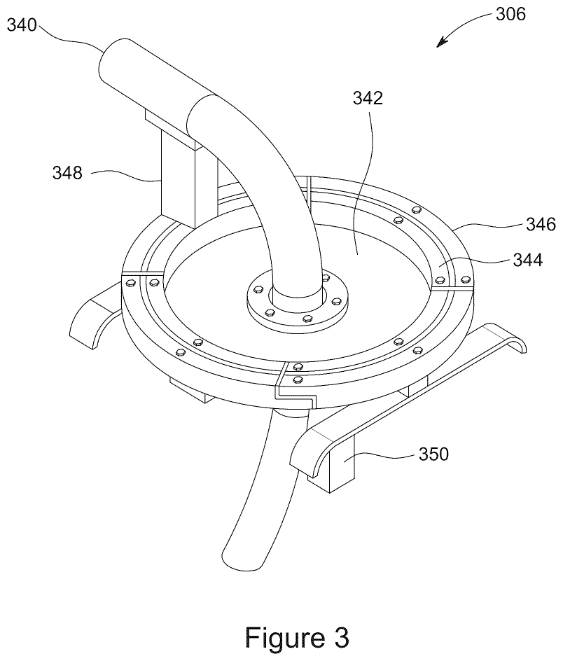

FIG. 3 shows a conveyance subassembly 306 according to one embodiment of the present arrangements. Conveyance subassembly 306 includes a conveyance tube 340 having an aperture that extends the length of conveyance tube 340 for conveying planting spikes from a first end to a second end. Conveyance tube 340 is coupled to a swivel mechanism that includes an outer ring 346, an inner ring 344, and a rotating plate 342 coupled to inner ring 344.

Outer ring 346 is configured to be coupled to a subaquatic planter via conveyance subassembly mounts 350. Inner ring 344 is rotatably coupled to outer ring 346 via one or more bearings, allowing inner ring 344 to rotate relative to outer ring 346. Conveyance tube 340 is secured to rotating plate 342, which is coupled to inner ring 344. This configuration enables the swivel mechanism to decouple rotational movement between the subaquatic planter and conveyance tube 340, thereby preventing torsional forces from acting on conveyance tube 340 during operation when the subaquatic planter rotates or changes orientation.

Conveyance subassembly 306 further includes a tube support 348 coupled to conveyance tube 340 at one end and inner ring 344 at another end. Tube support 348 ensures that conveyance tube 340 remains at a predetermined bend radius as the subaquatic planter moves, preventing kinking or excessive bending of conveyance tube 340 that could obstruct the flow of planting spikes or fluid.

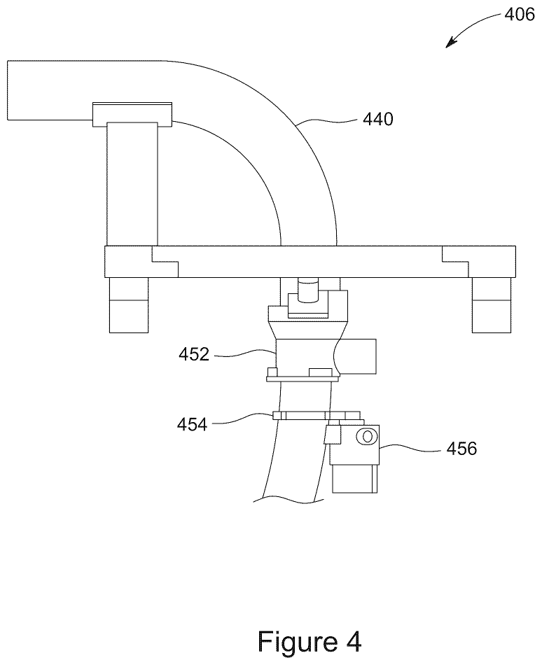

FIG. 4 shows a conveyance subassembly 406 according to one embodiment of the present arrangements. Conveyance subassembly 406, which is substantially similar to conveyance subassembly 306 of FIG. 3, includes a conveyance tube 440 with a pressure relief port 452 and a flow control mechanism 456 coupled thereto. Pressure relief port 452 is configured to release fluid from conveyance tube 440 when fluid pressure within conveyance tube 440 exceeds a predetermined amount, such as when a blockage occurs within conveyance tube 440. This prevents damage to conveyance tube 440 or other components due to excessive pressure buildup.

Flow control mechanism 456 includes a flap 454 disposed within conveyance tube 440. Flap 454 is configured to allow fluid flow from the first end of conveyance tube 440 toward the second end while inhibiting fluid flow from the second end toward the first end, thereby functioning as a check valve. In some embodiments, flap 454 may be adjusted to increase or decrease a cross-sectional area of the aperture within conveyance tube 440 to control the fluid flow rate, or to start and stop fluid from flowing through conveyance tube 440. Conveyance tube 440 extends downward from flow control mechanism 456 toward the seagrass planting subassembly.

FIGS. 5A, 5B, and 5C show a conveyance subassembly 506 according to one embodiment of the present invention. Conveyance subassembly 506 includes a diverter 508 that selectively directs fluid flow to different destinations. Diverter 508 includes a rotating valve 562 disposed within an internal chamber of diverter 508. Rotating valve 562 rotates to select between directing fluid flow to an exhaust port 568 and/or to one of a plurality of fluidic pathways.

In the illustrated embodiment of FIG. 5A, the plurality of fluidic pathways includes a first fluidic pathway 564 and a second fluidic pathway 566. First fluidic pathway 564 and second fluidic pathway 566 extend from diverter 508, and each conveys planting spikes to corresponding planting guides (e.g., planting guide 670 of FIG. 6). Exhaust port 568 is positioned at an upper portion of diverter 508 to allow fluid to exit diverter 508 without entering the plurality of fluidic pathways.

Rotating valve 562 is coupled to a motor shaft 560, which extends through diverter 508 and is coupled to a diverter motor 520. Diverter motor 520 rotates motor shaft 560, thereby rotating rotating valve 562 within diverter 508. By rotating rotating valve 562 to different angular positions, diverter motor 520 controls which destination receives fluid flow. In one embodiment of the present arrangements, rotating valve 562 is positioned to direct fluid flow to exhaust port 568, thereby preventing fluid from flowing into first fluidic pathway 564 or second fluidic pathway 566 and preventing fluid and planting spikes from entering the fluidic pathways and the associated planting channels. In another embodiment of the present arrangements, rotating valve 562 is positioned to direct fluid flow to first fluidic pathway 564 while blocking fluid flow to second fluidic pathway 566 and exhaust port 568. In yet another embodiment of the present arrangements, rotating valve 562 is positioned to direct fluid flow to second fluidic pathway 566 while blocking fluid flow to first fluidic pathway 564 and exhaust port 568.

While the embodiment described in FIG. 5 uses a rotating valve 562, the present teachings are not so limited. A ball valve diverter, sliding plate diverter, multiple discrete valves controlled in sequence, or electrohydraulic diverter may also be used.

FIG. 6 shows a seagrass planting subassembly 602 according to one embodiment of the present invention. Seagrass planting subassembly 602 includes a diverter 608 that selectively directs fluid flow to different destinations. Diverter 608 has a first fluidic pathway 644 extending therefrom that conveys planting spikes to a planting guide 670. Planting guide 670 defines a planting channel that receives and guides planting spikes as they are inserted into the subaquatic substrate.

Seagrass planting subassembly 602 includes a first door 612 positioned adjacent to planting guide 670. First door 612 retains a planting spike within the planting channel of planting guide 670 and inhibits fluid flow through the planting channel, thereby preventing fluid from exiting the planting channel and disturbing sediments on the subaquatic substrate. In operation, first door 612 moves between a closed position, where first door 612 blocks the planting channel, and an open position, where first door 612 allows the planting spike to pass through.

A first insertion ram 610 is positioned adjacent to planting guide 670 and operates to push the planting spike from planting guide 670 into the subaquatic substrate. First insertion ram 610 moves between a retracted position and an extended position. A first insertion motor 622 drives first insertion ram 610, causing first insertion ram 610 to move from the retracted position to the extended position, thereby pushing the planting spike into the subaquatic substrate. In one embodiment, a belt 668 couples first insertion motor 622 to first insertion ram and transfers rotational motion from first insertion motor 622 into linear motion of first insertion ram 610.

Belt 668, in one embodiment of the present arrangements, having a teeth pattern defined thereon that matches the teeth pattern of the belt pulley, extends between a belt pulley coupled to first insertion motor 622 and a vertical tensioner. Between the belt pulley and the vertical tensioner, the belt 668 may engage with a pull tensioner and a push tensioner. Together, the pull tensioner and the push tensioner ensure that the belt remains taught and prevents slipping between belt 668 and belt pulley. In another embodiment, the belt pulley and belt do not have teeth, and the pull tensioner, push tensioner, and vertical tensioner provide sufficient tension to prevent slipping between the belt pulley and belt through friction alone.

In one embodiment, seagrass planting subassembly 602 includes a first vibrating motor 630 coupled to first insertion ram 610. During insertion of the planting spike into the subaquatic substrate, first vibrating motor 630 vibrates first insertion ram 610, which in turn vibrates the planting spike. The vibration causes liquefaction of the subaquatic substrate surrounding the planting spike, thereby reducing the force required to insert the planting spike into the subaquatic substrate.

In yet another embodiment of the present arrangements, first insertion ram 610 is disposed between and movably coupled to a first rod and a second rod. The first rod and second rod are coupled to seagrass planter 104. In one embodiment of the present arrangements, first insertion ram 610 includes one or more wheels that rotatably contact the first rod and/or the second rod to align and/or guide first insertion ram 610 traversing along the first rod and/or the second rod. In a preferred embodiment of the present arrangements, first insertion ram 610 includes two sets of wheels. Each set of wheels contacts an opposing surface of the first rod or the second rod, respectively, to allow linear displacement of first insertion ram 610 relative to the first rod and the second rod.

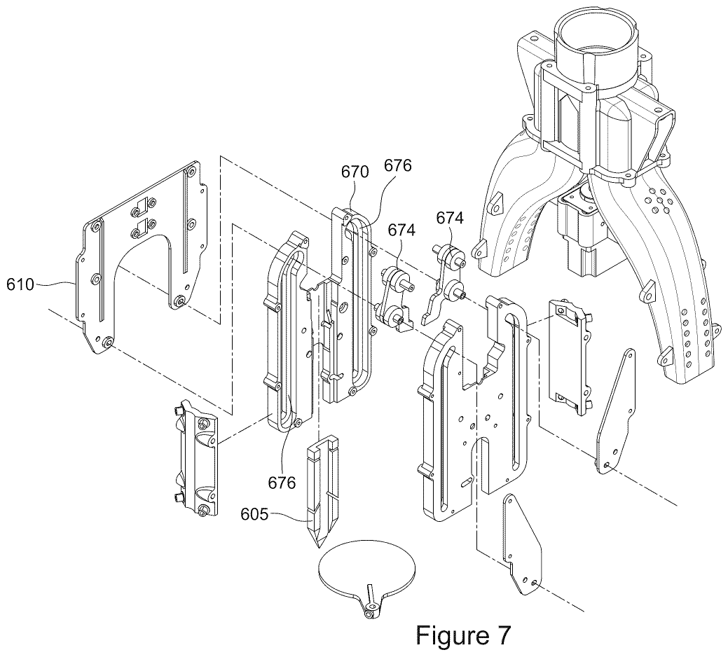

FIG. 7 shows an exploded view of seagrass planting subassembly 602 of FIG. 6. Seagrass planting subassembly 602 includes a planting guide 670 having pushing tang slots 676 defined therein. Planting guide 670 houses multiple pushing tangs 674 that are disposed within the pushing tang slots 676. A first insertion ram 610 couples to pushing tangs 674 drives vertical movement of pushing tangs 674 within pushing tang slots 676 during operation of seagrass planting subassembly 602. In one embodiment, first insertion ram 610 sandwiches planting guide 670, with first insertion ram 610 positioned on opposite sides of planting guide 670 to provide structural support and force transmission.

In one embodiment of the present arrangements, each of pushing tangs 674 includes one or more bushings disposed within pushing tang slot 676. The bushings facilitate smooth vertical motion of pushing tangs 674 within pushing tang slot 676 by reducing friction between pushing tangs 674 and the walls of pushing tang slots 676. In another embodiment of the present arrangements, planting guide 670 includes two components that, when coupled together, form planting guide 670. The two-component construction of planting guide 670 allows for assembly of pushing tangs 674 and associated bushings within pushing tang slots 676 before the two components are joined together. A planting spike 605 is shown positioned for insertion through planting guide 670. During operation, pushing tangs 674 engage planting spike 605 and drive planting spike 605 downward through planting guide 670 and into the subaquatic substrate as first insertion ram 610 moves to an extended position.

Pushing tangs 674, in one aspect of the present arrangements, are mechanically coupled to insertion ram 610 such that as insertion ram 610 moves downward, at least a portion of pushing tangs 674 are forced to extend in toward the planting channel of planting guide 670 due to the geometry of the coupling mechanism. In another embodiment, pushing tangs 674 may be spring-loaded to bias them toward the extended position, with insertion ram 610 compressing the springs as it moves to the retracted position.

During operation, pushing tangs 674 engage planting spike 605 at force receiving end 778 and drive planting spike 605 downward through planting guide 670 and into the subaquatic substrate as first insertion ram 610 moves to an extended position. The seagrass segment secured to planting spike 605 is thereby planted within the subaquatic substrate, where it can establish roots and continue growing.

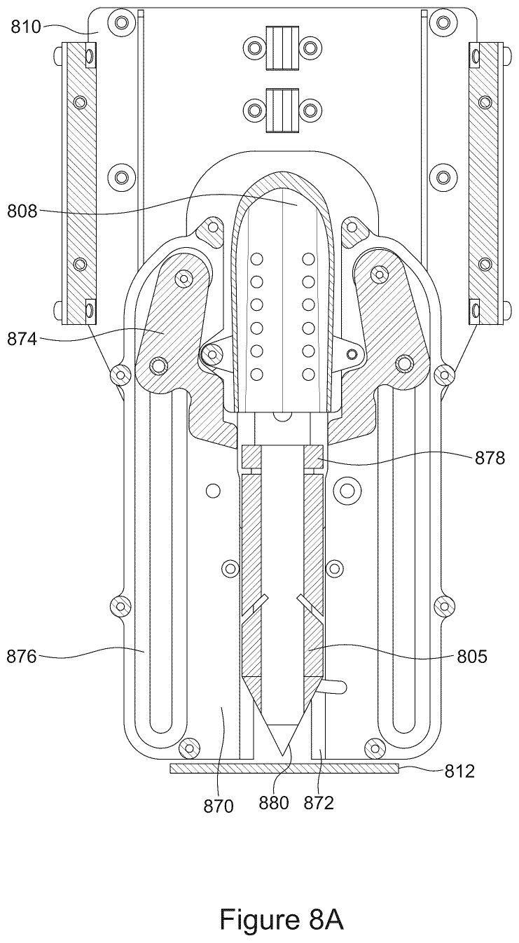

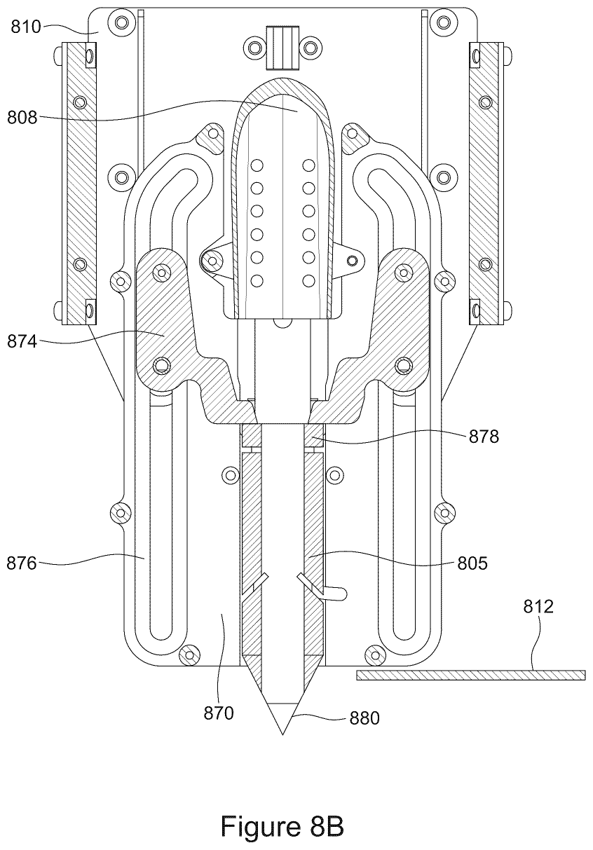

FIGS. 8A and 8B show a seagrass planting subassembly according to one embodiment of the present invention, illustrating insertion ram 810 moving from a retracted position to an extended position and the corresponding interaction with a planting spike 805.

As shown in FIG. 8A, insertion ram 810 is in the retracted position. A planting guide 870 has defined therein a planting channel 872 that receives planting spike 805. Planting spike 805 includes a force receiving end 878 positioned at an upper portion of planting spike 805 and a tine end 880 positioned at a lower portion of planting spike 805. Tine end 880 is the end that penetrates the subaquatic substrate during insertion. A door 812 is positioned adjacent to planting guide 870 and retains planting spike 805 within planting channel 872. A diverter 808 is positioned above planting guide 870 and directs planting spikes into planting channel 872.

Insertion ram 810 is coupled to pushing tangs 874. Planting guide 870 includes pushing tang slots 876 that receive pushing tangs 874. Each pushing tang 874 includes two bushings disposed within pushing tang slot 876. Pushing tang slot 876 defines a cam profile including an offset cam portion at an upper end and a substantially vertical guide portion extending downward from the offset cam portion. The offset cam portion is laterally offset from the vertical guide portion, creating a cam track that controls rotational orientation of pushing tang 874 during vertical translation of insertion ram 810.

In the retracted position shown in FIG. 8A, one of the two bushings on each pushing tang 874 is disposed within the offset cam portion of pushing tang slot 876. The lateral offset causes pushing tang 874 to rotate to a recessed orientation in which a contact surface of pushing tang 874, configured to engage force receiving end 878 of planting spike 805, is rotated outward from planting channel 872 and does not obstruct planting channel 872. This recessed orientation allows planting spike 805 to enter and be positioned within planting channel 872 without interference from pushing tangs 874. The gap between the contact surfaces of pushing tangs 874 and force receiving end 878 permits planting spike 805 to be positioned within planting channel 872 while insertion ram 810 remains in the retracted position.

As shown in FIG. 8B, insertion ram 810 is moving toward the extended position. As insertion ram 810 moves from the retracted position toward the extended position, the bushing on each pushing tang 874 travels along the cam profile from the offset cam portion into the vertical guide portion of pushing tang slot 876. This transition along the cam profile causes pushing tang 874 to rotate to an extended orientation in which the contact surface rotates into planting channel 872 and engages force receiving end 878 of planting spike 805. The bushings function as cam followers that track along the cam profile defined by pushing tang slot 876, converting vertical motion of insertion ram 810 into combined rotational and translational motion of pushing tangs 874.

Continued downward movement of insertion ram 810 maintains pushing tangs 874 in the extended orientation while translating pushing tangs 874 vertically downward within the vertical guide portions of pushing tang slots 876. Pushing tangs 874 now contact force receiving end 878 of planting spike 805 and transmit downward force from insertion ram 810 to planting spike 805, thereby driving planting spike 805 out of planting guide 870 and into the subaquatic substrate. Tine end 880 penetrates the subaquatic substrate while pushing tangs 874 maintain continuous contact with force receiving end 878, ensuring efficient force transmission. Door 812 has opened to allow planting spike 805 to exit planting channel 872 and enter the subaquatic substrate. This cam-actuated embodiment provides an advantage in that it automatically synchronizes the rotational positioning of pushing tangs 874 with the vertical position of insertion ram 810, ensuring that pushing tangs 874 do not interfere with planting spike 805 during loading, but reliably engage force receiving end 878 during insertion without requiring separate actuation mechanisms for rotation and translation. Moreover, when door 812 is in the closed position and pushing tangs 874 contact force receiving end 878 of planting spike 805, pushing tangs 874 inhibit or prevent planting spike 874 from traversing back towards the diverter 808.

A planting spike 805 is shown positioned for insertion through planting guide 870. Planting spike 805, according to one embodiment of the present arrangements, secures a seagrass segment within the subaquatic substrate. Planting spike 805 includes a force receiving end 878, a body, and a tine end 880. Force receiving end 878 receives a force from pushing tangs 874 of first insertion ram 810. Preferably, force receiving end 878 has a maximum width that is equal to or less than an inner diameter of the planting channel to allow planting spike 805 to move freely through the planting channel. At least a portion of force receiving end 878 allows a portion of the seagrass segment (e.g., one or more leaves) to extend above planting spike 805. Another portion of the seagrass segment is disposed adjacent to and is secured to the body of planting spike 805 using a securing mechanism (e.g., wire, string, clip, or adhesive). Tine end 880 includes one or more surfaces or edges that converge or narrow to form, for example, a penetrating point that facilitates insertion into the subaquatic substrate.

In one embodiment of the present arrangements, planting spike 805 is produced from a single piece of material. By way of example, planting spike 805 is stamped from a material using a die and then bent to the shape described herein. By way of another example, planting spike 805 is produced using a 3D printer or additive manufacturing process. The present arrangements, however, are not so limited, and a combination of two or more separate components may be joined together to produce planting spike 805. In one embodiment of the present arrangements, planting spike 805 is made of a material that biodegrades or corrodes when exposed to saltwater and/or the subaquatic substrate, thereby minimizing long-term environmental impact. Planting spike 805 may be made from at least one material selected from a group including biodegradable plastic (i.e., plastic derived from plants), steel, aluminum, plant-based materials, biodegradable concrete, bamboo, and fungi-based materials. The biodegradable or corrodible nature of planting spike 805 allows the spike to remain in the substrate long enough to secure the seagrass segment during initial root establishment, then decompose over time as the seagrass becomes self-sustaining.

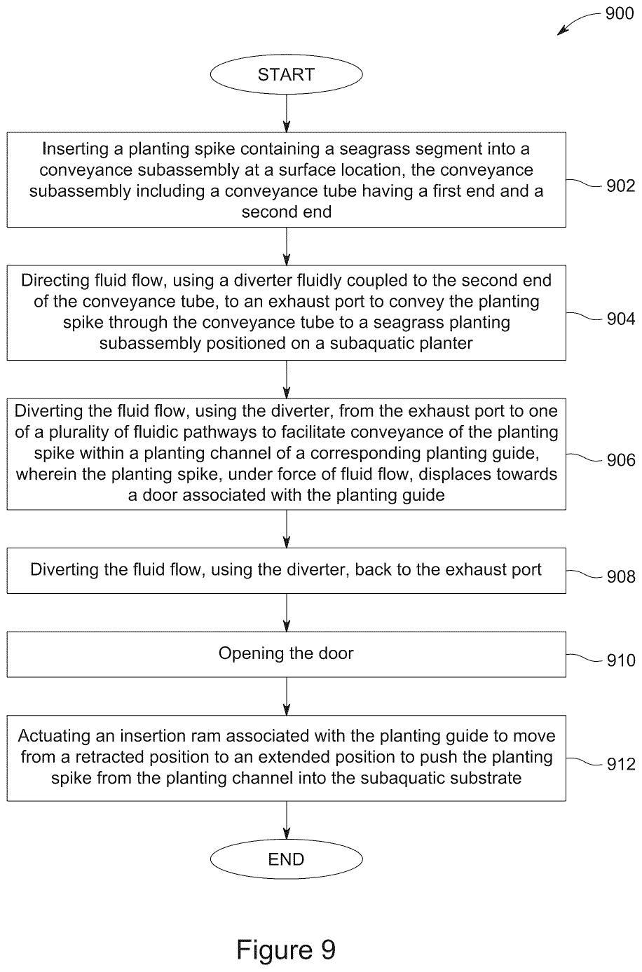

FIG. 9 shows a method 900 for planting seagrass segments within a subaquatic substrate, according to one embodiment of the present teachings. The method begins with an element 902, which includes inserting a planting spike containing a seagrass segment into a conveyance subassembly (e.g., conveyance subassembly 106 of FIG. 1) at a surface location. The conveyance subassembly includes a conveyance tube having a first end and a second end. The conveyance receives the planting spike (e.g., planting spike 805 of FIGS. 8A and 8B) at the first end of the conveyance tube at the surface location, such as on a boat or surface platform, and conveys the planting spike toward a seagrass planting subassembly positioned on a subaquatic planter underwater.

Following element 902, an element 904 is carried out, which includes directing fluid flow, using a diverter (e.g., diverter 208 of FIG. 2) fluidly coupled to the second end of the conveyance tube, to an exhaust port to convey the planting spike through the conveyance tube to the seagrass planting subassembly. The diverter selectively directs fluid flow to the exhaust port (e.g., exhaust port 568 of FIG. 5) rather than to a plurality of fluidic pathways leading to a plurality of planting channels. By directing fluid flow to the exhaust port, the method prevents fluid flow through the fluidic pathways and planting channels, thereby preventing disturbance of sediments on the subaquatic substrate. Preferably, the fluid flow includes water from the subaquatic environment in which the subaquatic planter is disposed. In one embodiment of the present teachings, the diverter includes a rotating valve (e.g., rotating valve 562 of FIG. 5), and directing fluid flow includes rotating the rotating valve to select the exhaust port as the destination for fluid flow. A diverter motor (e.g., diverter motor 220 of FIG. 2) drives rotation of the rotating valve, causing the rotating valve to direct fluid to the exhaust port. In one embodiment of the present teachings, a bi-directional pump (e.g., bi-directional pump 218 of FIG. 2) positioned between the surface location and the subaquatic planter adjusts the flow rate of the fluid flow. The bi-directional pump controls both the direction and rate of fluid flow through the conveyance subassembly. In some instances, if a planting spike becomes stuck within the conveyance subassembly or the diverter, the method includes reversing the direction of fluid flow using the bi-directional pump to reposition the planting spike. Reversing the fluid flow dislodges the stuck planting spike and allows it to be repositioned or removed.

Next, an element 906 includes diverting the fluid flow, using the diverter, from the exhaust port to one of a plurality of fluidic pathways to facilitate conveyance of the planting spike within a planting channel of a corresponding planting guide. The diverter, in one embodiment of the present teachings, redirects fluid flow from the exhaust port to a selected fluidic pathway (e.g., first fluidic pathway 564 or second fluidic pathway 566 of FIG. 5). The selected fluidic pathway directs the planting spike and fluid flow into a planting channel (e.g., planting channel 872 of FIGS. 8A and 8B) defined within a planting guide (e.g., planting guide 670 of FIGS. 6 and 7). The planting spike, under force of fluid flow, displaces towards a door (e.g., door 812 of FIGS. 8A and 8B) associated with the planting guide. The fluid flow pushes the planting spike through the fluidic pathway and into the planting channel until the planting spike contacts or is proximate to the door.

Fluid flow through the conveyance subassembly, in one embodiment of the present teachings, holds the planting spike in position against the door. In other words, continuous fluid flow exerts pressure on the planting spike, keeping the planting spike pressed against the door and preventing the planting spike from moving backward within the planting channel.

Following element 806, an element 908 is carried out, which includes diverting the fluid flow, using the diverter, back to the exhaust port. Once the planting spike is positioned within the planting channel against the door, the diverter redirects fluid flow away from the fluidic pathway and back to the exhaust port. This prevents fluid from flowing through the planting channel and exiting past the door, which would otherwise disturb sediments on the subaquatic substrate and reduce water clarity for cameras monitoring the planting operation.

Method 900 continues with an element 910, which includes opening the door. A door motor (e.g., first door motor 226 or second door motor 228 of FIG. 2) actuates the door, moving the door from a closed position to an open position. In the open position, the door no longer blocks the planting channel, allowing the planting spike to pass through and exit the planting guide.

Next, an element 912 includes actuating an insertion ram (e.g., first insertion ram 210 or second insertion ram 214 of FIG. 2) associated with the planting guide to move from a retracted position to an extended position to push the planting spike from the planting channel into the subaquatic substrate. An insertion motor (e.g., first insertion motor 222 or second insertion motor 224 of FIG. 2) drives the insertion ram. When the insertion ram is in the retracted position, pushing tangs (e.g., pushing tangs 674 of FIG. 7) reside in a recessed position and do not contact the force receiving end of the planting spike. As the insertion ram moves from the retracted position to the extended position, the pushing tangs extend into the planting channel and engage with the force receiving end of the planting spike, driving the planting spike downward out of the planting guide and into the subaquatic substrate.

In one embodiment of the present teachings, actuating the insertion ram occurs contemporaneously with opening the door. In yet another embodiment, actuating the insertion ram is carried out first. During actuation, the door is then opened.

Method 900, in another embodiment of the present teachings, includes activating a vibrating motor coupled to the insertion ram during the actuating of the insertion ram in element 912. The vibrating motor (e.g., first vibrating motor 230 or second vibrating motor 232 of FIG. 2) vibrates the insertion ram, which in turn vibrates the planting spike. The vibration causes liquefaction of the subaquatic substrate surrounding the planting spike, reducing the force (i.e, pushing force and/or friction force) required to insert the planting spike into the subaquatic substrate. Vibration, in other words, causes a temporary fluidization of the subaquatic substrate.

In one embodiment, method 900 includes sequentially planting multiple planting spikes using multiple insertion rams. After completing element 912 with a first insertion ram pushing a first planting spike into the subaquatic substrate, method 900 includes inserting a second planting spike containing a seagrass segment into the conveyance subassembly and diverting fluid flow to position the second planting spike within a second planting channel of a second planting guide. While the first insertion ram is pushing the first planting spike into the subaquatic substrate during element 912, the diverter can simultaneously or sequentially direct the second planting spike to the second planting channel, allowing for efficient sequential planting. Method 900 then includes actuating a second insertion ram to push the second planting spike into the subaquatic substrate after the first planting spike has been inserted.

In one embodiment of the present teachings, the seagrass planting system includes one or more sensors for monitoring planting operations. Sensors may include cameras for visual monitoring, pressure sensors for monitoring fluid pressure within the conveyance tube and diverter, position sensors for determining insertion ram position, and/or depth sensors for determining planting depth. A controller (e.g., programmable logic controller, microcontroller, or computer) receives signals from the sensors and controls operation of the diverter motor, insertion motors, door motors, and bi-directional pump according to a programmed planting sequence.

In another embodiment of the present teachings, method 900 includes maneuvering the subaquatic planter to a desired planting location on the subaquatic substrate before or between planting operations. Propulsion systems (e.g., ducted thrusters) positioned on the subaquatic planter control movement of the subaquatic planter, allowing the subaquatic planter to traverse the subaquatic substrate and position itself at desired planting locations where seagrass restoration is needed.

What is claimed is:

1. A seagrass planting system for planting seagrass segments within a subaquatic substrate, the system comprising:
a conveyance subassembly configured to receive planting spikes from a surface location, the conveyance subassembly including a conveyance tube having a first end and a second end;
a subaquatic planter coupled to the conveyance subassembly and configured to operate underwater and including:
a seagrass planting subassembly positioned on the subaquatic planter, the seagrass planting subassembly including:
a diverter fluidly coupled to the second end of the conveyance tube, the diverter configured to selectively direct fluid flow to an exhaust port or to one of a plurality of fluidic pathways;
a plurality of planting guides, each planting guide associated with one of the plurality of fluidic pathways, each planting guide having a planting channel configured to receive a planting spike from its associated fluidic pathway;
a plurality of doors, each door associated with one of the plurality of planting guides and configured to retain a planting spike within the planting channel and inhibit fluid flow through the planting channel, wherein in an operative state the planting spike, under force of fluid flow, displaces towards the door; and
a plurality of insertion rams, each insertion ram associated with one of the plurality of planting guides and configured to move from a retracted position to an extended position to push the planting spike from the planting channel into the subaquatic substrate;
wherein the diverter is configured to sequentially direct fluid flow to the exhaust port, to one of the plurality of fluidic pathways to facilitate conveyance of the planting spike, within the planting channel, adjacent to one of the plurality of doors, and to the exhaust port prior to opening the door and actuating one of the plurality of insertion rams to push the planting spike into the subaquatic substrate.

2. The seagrass planting system of claim 1, wherein the diverter includes a rotating valve controlled by a diverter motor, the rotating valve directing fluid flow to the exhaust port or one of the plurality of planting guides.

3. The seagrass planting system of claim 2, wherein the rotating valve directs fluid flow to a first fluidic pathway to facilitate conveyance of a first planting spike adjacent to a first door, and to the exhaust port prior to opening the first door, to a second fluidic pathway to facilitate conveyance of a second planting spike adjacent to a second door, and to the exhaust port prior to opening the second door.

4. The seagrass planting system of claim 1, wherein each door is actuatable between a closed position and an open position, wherein in the closed position the door retains the planting spike within the planting channel and prevents fluid flow through the door so as to minimize disturbance upon the subaquatic substrate.

5. The seagrass planting system of claim 1, wherein each insertion ram includes pushing tangs configured to engage a force receiving end of the planting spike, wherein when the insertion ram is in the retracted position, the pushing tangs are in a recessed position that does not engage the planting spike when the planting spike is positioned within the planting channel, and wherein when the insertion ram is moving from the retracted position to the extended position, the pushing tangs extend into the planting channel and engage with the force receiving end of the planting spike to push the planting spike into the subaquatic substrate.

6. The seagrass planting system of claim 1, wherein the diverter includes one or more apertures defined therethrough, the one or more apertures configured to exhaust fluid from the selected one of the plurality of fluidic pathways, thereby controlling fluid pressure and/or fluid flow rate within the fluidic pathways.

7. The seagrass planting system of claim 1, comprising at least a first insertion ram and a second insertion ram, each associated with a different planting guide, wherein the seagrass planting subassembly is configured to sequentially plant planting spikes using the first insertion ram and the second insertion ram.

8. The seagrass planting system of claim 1, wherein the conveyance subassembly further comprising a swivel mechanism mounted on the subaquatic planter, the swivel mechanism comprising an outer ring configured to be coupled to the subaquatic planter, an inner ring rotatably coupled to the outer ring, and a rotating plate coupled to the inner ring and to the conveyance tube, wherein the swivel mechanism is configured to decouple rotational movement between the subaquatic planter and the conveyance tube.

9. The seagrass planting system of claim 1, further comprising a bi-directional pump fluidly coupled to the conveyance subassembly, the bi-directional pump configured to control direction and rate of fluid flow through the conveyance subassembly.

10. The seagrass planting system of claim 1, further comprising at least one vibrating motor coupled to at least one of the plurality of insertion rams, wherein the vibrating motor is configured to vibrate the insertion ram during insertion of the planting spike into the subaquatic substrate to fluidize the subaquatic substrate and reduce insertion force.

11. A method for planting seagrass segments within a subaquatic substrate, the method comprising:
inserting a planting spike containing a seagrass segment into a conveyance subassembly at a surface location, the conveyance subassembly including a conveyance tube having a first end and a second end;
directing fluid flow, using a diverter fluidly coupled to the second end of the conveyance tube, to an exhaust port to convey the planting spike through the conveyance tube to a seagrass planting subassembly positioned on a subaquatic planter;
diverting the fluid flow, using the diverter, from the exhaust port to one of a plurality of fluidic pathways to facilitate conveyance of the planting spike within a planting channel of a corresponding planting guide, wherein the planting spike, under force of fluid flow, displaces towards a door associated with the planting guide;
diverting the fluid flow, using the diverter, back to the exhaust port;
opening the door; and
actuating an insertion ram associated with the planting guide to move from a retracted position to an extended position to push the planting spike from the planting channel into the subaquatic substrate.

12. The method of claim 11, wherein the diverter includes a rotating valve, and wherein directing fluid flow includes rotating the rotating valve to select between the exhaust port and the selected one of the plurality of fluidic pathways.

13. The method of claim 11, further comprising maintaining fluid flow through the conveyance subassembly during positioning of the planting spike within the planting channel to hold the planting spike in position against the door.

14. The method of claim 11, further comprising activating a vibrating motor coupled to the insertion ram during the actuating of the insertion ram to cause vibration of the planting spike and liquefaction of the subaquatic substrate.

15. The method of claim 11, further comprising:
inserting a second planting spike containing a seagrass segment into the conveyance subassembly;
diverting fluid flow to position the second planting spike within a second planting channel of a second planting guide while the insertion ram is pushing the first planting spike into the subaquatic substrate; and
actuating a second insertion ram to push the second planting spike into the subaquatic substrate after the first planting spike has been inserted.

16. The method of claim 11, wherein the fluid flow includes water from a subaquatic environment in which the subaquatic planter is disposed.

17. The method of claim 11, wherein directing fluid flow to the exhaust port during conveyance prevents fluid flow through the plurality of fluidic pathways and the planting channels, thereby preventing disturbance of sediments on the subaquatic substrate.

18. The method of claim 11, further comprising adjusting a flow rate of the fluid flow using a bi-directional pump positioned between the surface location and the subaquatic planter.

19. The method of claim 18, further comprising reversing direction of fluid flow using the bi-directional pump to reposition a planting spike that is stuck within the conveyance subassembly or the diverter.

20. The method of claim 11, further comprising maneuvering the subaquatic planter to a desired planting location on the subaquatic substrate using propulsion systems positioned on the subaquatic planter.
